(19) United States
(12) Patent Application Publication
(10) Pub. No.: US 2007/0240153 A1
(43) Pub. Date: Oct. 11, 2007

(54) System and method for installing hypervisor after user operating system has been installed and loaded

(75) Inventors: Daryl Carvis Cromer, Cary, NC (US); Scott Edwards Kelso, Durham, NC (US); Howard Jeffrey Locker, Cary, NC (US); John Carl Mese, Cary, NC (US); Nathan J. Peterson, Raleigh, NC (US); Randall Scott Springfield, Chapel Hill, NC (US); Rod David Waltermann, Rougemont, NC (US); Arnold S. Weksler, Raleigh, NC (US)

Correspondence Address: ROGITZ & ASSOCIATES, 750 B STREET, SUITE 3120, SAN DIEGO, CA, 92101, US

(73) Assignee: Lenovo (Singapore) Pte. Ltd.

(21) Appl. No.: 11/394,277

(22) Filed: Mar. 29, 2006

(51) Int. Cl. G06F 9/445

(52) U.S. Cl. 717/174

(57) ABSTRACT

A system and method for installing a type-1 hypervisor onto a secondary storage of a computer while a user operating system is already installed and executing in main memory.

### I. FIELD OF THE INVENTION

The present invention relates generally to installing a hypervisor in a computer that has a user operating system (U.O.S.) installed and loaded.

### II. BACKGROUND OF THE INVENTION

Hypervisors are computer programs that allow different operating systems to run on the same hardware concurrently. This has many advantages, including resource isolation and the ability to concurrently run different operating systems and associated applications.

In a so-called “type 1” hypervisor, the hypervisor executes directly on the hardware, with the user operating systems running on top of the hypervisor and essentially controlling “virtualized” versions of devices (such as hard disk drives) within the hypervisor. Type-1 hypervisors allow good performance in each operating system as compared to so-called “type 2” hypervisors that execute on top of an existing operating system, i.e., a type-2 hypervisor is separated from the hardware by an existing operating system. As understood herein, type 1 hypervisors are ideally suited for client manageability, because, e.g., the first operating system may be a User Operating System (U.O.S.) such as Microsoft XP while the second operating system can be a Service Operating System (S.O.S.) such as Linux or Microsoft Windows PE that can be used for client manageability purposes.

The present invention critically recognizes that currently, it is not possible to install a type 1 hypervisor into a computer system after the operating system is installed and running. Instead, because type-1 hypervisors run directly on the hardware, the installation sequence currently requires installing the hypervisor on secondary storage and booting it into main memory before installing a user O.S. As critically recognized herein, however, a user with an existing computer and O.S. may wish to avail himself of the advantages of a type-1 hypervisor without first de-installing the O.S. and essentially starting from scratch.

### SUMMARY OF THE INVENTION

A method for installing a hypervisor on a secondary storage of a computer includes installing, onto the secondary storage, files of a type-1 hypervisor while a user operating system (O.S.) is executing on the computer.

In some implementations the method may includes updating a boot loader of the computer with information associated with the hypervisor. The method can further include loading the hypervisor into a main memory of the computer upon subsequent booting of the computer by using the information associated with the hypervisor in the boot loader to access files in the secondary storage associated with the hypervisor, and then copying the files into the main memory. After it is loaded, the hypervisor can load the user O.S. from the secondary storage into the main memory, or the boot loader running in the hypervisor can be used to load the user O.S. from the secondary storage into the main memory.

In another aspect, a computer system includes a processor, a main memory accessible by the processor during computer operation, and a secondary storage storing at least one operating system (O.S.) that is loadable into the main memory from secondary storage for execution by the processor to install a hypervisor into the secondary storage.

In still another aspect, a computer has a processor and means executable by the processor for installing a type-1 hypervisor onto a secondary storage associated with the computer while a user operating system (U.O.S.) is executing in a main memory associated with the computer.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting system architecture;

FIG. 2 is a flow chart of a non-limiting implementation of the hypervisor installation logic; and

FIG. 3 is a flow chart of a non-limiting implementation of the hypervisor load logic.

### DETAILED DESCRIPTION OF THE PREFERRED EMBODIMENT

As used herein, “install” means the act of placing software files on a secondary storage such as a hard disk drive and configuring the files in such a way that they can be run. On the other hand, “load” means temporarily copying installed program files from secondary storage into a main memory from which a computer processor executes the software during operation. Some transformations may be applied to the program files in the process of loading them.

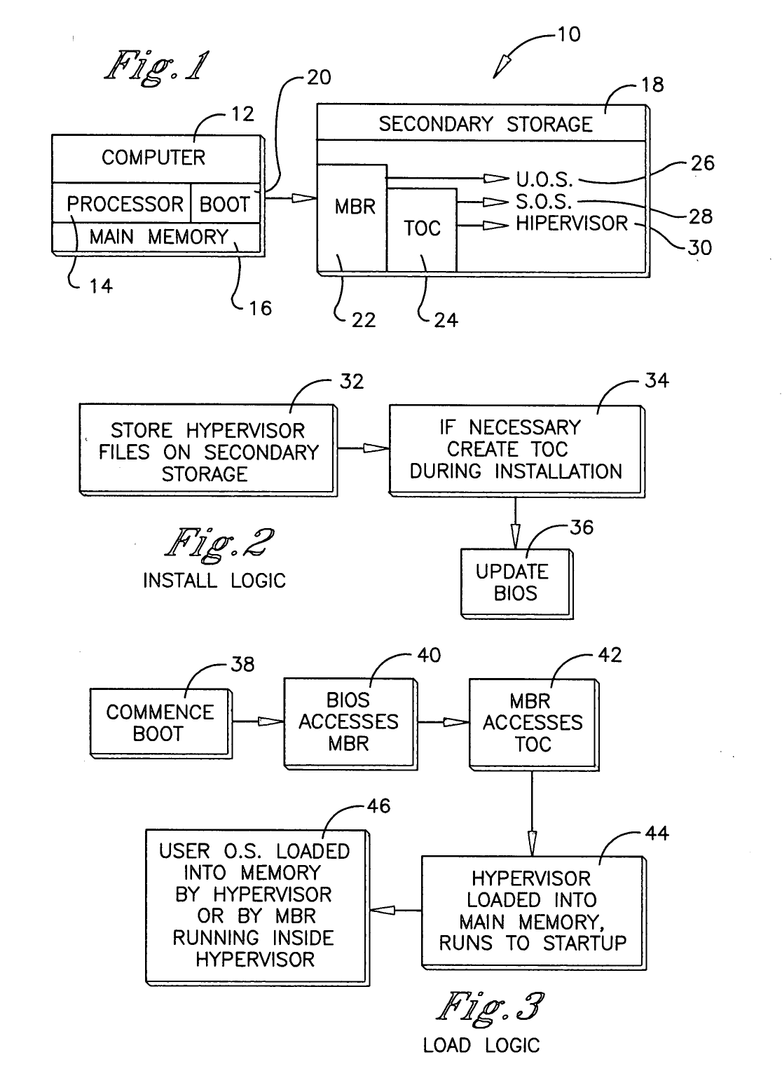

Referring initially to FIG. 1, a system is shown, generally designated 10, which includes a computer 12 such as but not limited to a personal computer, laptop computer, notebook computer, etc. with associated processor 14. During operation the processor 14 accesses a main memory 16 of the computer 12 in accordance with operating principles known in the art to execute one or more operating systems that have been loaded into the main memory 16 from a secondary storage 18 by a boot component 20. The secondary storage 18 may be a hard disk drive or solid state memory such as Flash memory or other type of storage, and the boot component 20 may be a basic input-output system (BIOS) or other boot operating system.

As shown in FIG. 1, the system 10 also includes a master boot record (MBR) 22 and in some implementations a table of contents (TOC) 24 that can be stored on the secondary storage 18 as shown, with pointers to the MBR 22 and TOC 24 being stored by the boot component 20. Or, one or both of the MBR 22 and TOC 24 may be stored by the boot component 20 itself. In any case, the MBR 22 can contain a pointer to the TOC 24, and the TOC 24 in turn can be a table of pointers to files of a user operating system (U.O.S.) 26 such as but not limited to Microsoft XP®, a service O.S. 28 such as but not limited to Linux or Microsoft Windows PE® that can be used for client manageability purposes, and, after the logic below, a type 1 hypervisor 30. In the non-limiting implementation shown, the U.O.S. 26 is loaded into memory by the MBR 22.

With the above system architecture in mind, the hypervisor 30 may be installed on the secondary storage 18 using the logic of FIG. 2 after the U.O.S. 26 has been installed. Commencing at block 32, with the U.O.S. 26 installed in the secondary storage 18 and running in the main memory 16, the hypervisor 30 is installed onto the secondary storage 18 by copying its files onto the secondary storage 18. In non-limiting implementations this is accomplished by copying the hypervisor bits to a file or files (either contiguous or non-contiguous) in the space in secondary storage 18 that can be reserved for the U.O.S.

As understood by the present invention, the program that loads the hypervisor 30 may be capable of interpreting the native file system on the secondary storage 18, in which case no new TOC 24 information need be generated. The present invention understands, however, that it is not uncommon for the secondary storage 18 to be formatted with a file system the specification for which may be proprietary. In such an instance, the logic flows to block 34 wherein the hypervisor files are accessed to locate their sectors, with the hypervisor sector location information being recorded in a file of the TOC 24. Then, at block 36 the boot component 20 (e.g., BIOS) is updated accordingly, either by loading the TOC 24 with new hypervisor location information into the boot component 20 or by recording, in the boot component 20 or in the MBR 22, a pointer to the first sector of the TOC 24 (which contains pointers to the hypervisor locations in secondary storage).

In the event that the secondary storage 18 is mostly blank and no U.O.S. is available, an area in the secondary storage may be reserved for the hypervisor, which is then copied into the reserved space. As mentioned above, the cluster offsets for each piece of the hypervisor may or may not be contiguous.

After installation, the computer 12 can be rebooted using the logic shown in FIG. 3 to load the hypervisor 30 into the main memory 16. The boot is commenced at block 38, and then an initial boot loader such as the boot component 20 (e.g., BIOS), the MBR 22, or a hypervisor boot loader (HBL) uses the TOC to reconstruct the hypervisor in memory for booting. In the specific non-limiting logic shown in FIG. 3, at block 40 the boot component 20 such as BIOS accesses the MBR 22, and then the MBR 22 accesses the TOC 24 at block 42 using, e.g., the above-mentioned pointer.

When the hypervisor 30 has been installed and the TOC 24 configured as discussed above in relation to FIG. 2, the initial boot loader (e.g., the MBR 22) detects hypervisor location information (e.g., pointers to locations on the secondary storage 18 that contain the hypervisor) in the TOC 24. Using the pointer information, the hypervisor 30 is loaded into the main memory 16 at block 44, with the hypervisor 30 running to start up, wherein the hypervisor boots and “virtualizes” the hardware in accordance with hypervisor principles known in the art.

Next, at block 46 the user O.S. 26 (and if desired the service O.S. 28) can be loaded into memory with the hypervisor 30 running. This may be done by the hypervisor 30 itself, or the hypervisor 30 may relinquish control back to the initial boot loader (e.g., the MBR 22) so that the initial boot loader (now being executed within the hypervisor “virtual” space instead of directly on the hardware) can load the U.O.S. 26 into the main memory 16.

While the particular SYSTEM AND METHOD FOR INSTALLING HYPERVISOR AFTER USER OPERATING SYSTEM HAS BEEN INSTALLED AND LOADED is herein shown and described in detail, it is to be understood that the subject matter encompassed by the present invention is limited only by the claims. For example, although the system and method herein can be undertaken to install a type-1 hypervisor after an operating system has been installed, it may also be used to install a hypervisor before O.S. installation.

What is claimed is:

1. A method for installing a hypervisor on a secondary storage of a computer, comprising:
while a user operating system (O.S.) is executing on the computer, installing, onto the secondary storage, files of a type-1 hypervisor.

2. The method of claim 1, further comprising:
updating a boot loader of the computer with information associated with the hypervisor.

3. The method of claim 2, further comprising:
loading the hypervisor into a main memory of the computer upon subsequent booting of the computer.

4. The method of claim 3, wherein the act of loading includes:
using the information associated with the hypervisor in the boot loader to access files in the secondary storage associated with the hypervisor; and
copying the files into the main memory.

5. The method of claim 4, further comprising using the hypervisor to load the user O.S. from the secondary storage into the main memory.

6. The method of claim 4, further comprising using the boot loader running in the hypervisor to load the user O.S. from the secondary storage into the main memory.

7. A computer system, comprising:
at least one processor;
at least one main memory accessible by the processor during computer operation; and
at least one secondary storage storing at least one operating system (O.S.) loadable into the main memory from secondary storage and executable by the processor to install at least one hypervisor into the secondary storage.

8. The system of claim 7, wherein the hypervisor is a type-1 hypervisor.

9. The system of claim 7, wherein the operating system is at least one of: a user operating system (U.O.S.), or a service OS.

10. The system of claim 9, comprising at least one boot loader executable by the processor to copy the U.O.S. into the main memory from the secondary storage.

11. The system of claim 10, wherein the boot loader is updated with information associated with the hypervisor.

12. The system of claim 11, wherein the hypervisor is loaded into the main memory upon booting of the computer subsequent to hypervisor installation.

13. The system of claim 12, wherein the hypervisor is loaded at least in part by using the information associated with the hypervisor in the boot loader to access files in the secondary storage associated with the hypervisor, and then copying the files into the main memory.

14. The system of claim 13, wherein the hypervisor loads the user O.S. from the secondary storage into the main memory.

15. The system of claim 13, wherein the boot loader running in the hypervisor loads the user O.S. from the secondary storage into the main memory.

16. A computer, comprising:
at least one processor; and
means executable by the processor for installing a type-hypervisor onto a secondary storage associated with the computer while a user operating system (U.O.S.) is executing in a main memory associated with the computer.

17. The computer of claim 16, comprising at least one boot loader executable by the processor to copy the U.O.S. into the main memory from the secondary storage.

18. The computer of claim 17, wherein the hypervisor is loaded into main memory at least in part by using information associated with the hypervisor in the boot loader to access files in the secondary storage associated with the hypervisor, and then copying the files into the main memory.

19. The computer of claim 18, wherein the hypervisor loads the user O.S. from the secondary storage into the main memory.

20. The computer of claim 18, wherein the boot loader running in the hypervisor loads the user O.S. from the secondary storage into the main memory.
